(19) United States
(12) Patent Application Publication
(10) Pub. No.: US 2005/0267811 A1
(43) Pub. Date: Dec. 1, 2005

(54) Systems and methods of ordering at an automated food processing machine

(76) Inventor: Robert E. Almblad, Mundelein, IL (US)

Correspondence Address: Michael R. McKenna, Suite 3800, 500 West Madison, Chicago, IL, 60661, US

(21) Appl. No.: 10/848,661

(22) Filed: May 17, 2004

(51) Int. Cl. G06F 17/60

(52) U.S. Cl. 705/15

(57) ABSTRACT

A customer of an Automated Food Preparation Machine communicates via telephone to a remotely located human order taker who negotiates a food order from a menu that is accessible to the customer and then via the Internet, the order taker obtains control of the remotely located Automated Food Preparation Machine and activates it to produce an ordered menu item.

### BACKGROUND OF THE INVENTION

This invention relates to systems and methods of ordering at an Automated Food Processing Machine—a machine that keeps food refrigerated and automatically cooks and delivers hot meals. These hot meals are made simultaneously in multiple ovens, so that as many as 20 meals for 20 different people can be made in 5 minutes. The type of machine that stores and prepares meals automatically is called an Automated Food Preparation Machine (AFPM).

In any advanced automated food delivery system the main problem is how to take the customer's order and get paid as fast as you prepare the meal. The present method at any restaurant is to take the customer's order in a serial fashion with one customer waiting behind the next customer. However, if you can deliver 20 meals for 20 different people in 5 minutes, how can you take the orders from all customers in one or two minutes without hiring a bunch of order takers? One solution is to use a bunch of kiosks in a restaurant. However, no one likes using a kiosk. On the other hand when you hire lots of order takers it is very expensive and inefficient because they are only busy during rush hour. Consequently, even regular restaurants hire as few order takers as possible and make you, the customer, wait in line during the rush hour.

Automated Food Preparation Machines (AFPM) have dramatically reduced the number of personnel needed in the food service business through automation and the use of robotics. In U.S. Pat. No. 5,503,300, issued Apr. 2, 1996, and titled “Vending Machine Including Refrigeration And Oven Compartments”, the automation process reduced the number of food service personnel needed to deliver a hot meal to 0. In this “Hot Choice” vending machine, the customer interacts directly with the machine to get it to produce his meal. These limited menu vending AFPMs are operated by one customer at a time, in a serial fashion: 1) 1 of about 4 menu items is selected by the customer, 2) the item selected is then prepared and delivered to the customer, and 3) once this cycle is complete, the next person can use the machine. This serial use of the machine makes it slow to deliver if 20 people try to order at the same time, such as at breakfast and lunch time.

To solve this problem, new advanced AFPMs are being developed where the menu items are expanded and multiple customers can use the machine at the same time in order to speed up delivery. But, the problem is how can 20 people place an order at the same time.

To alleviate this problem, and others which will become apparent from the disclosure which follows, the present invention conveniently has the customer read a menu and call an order taker on the phone. The order taker would use the Internet to activate the Automated Food Preparation Machine. The cost of phone today is negligible, so a national system of machines would be able to take advantage of time zones so all the order taker would stay busy all the time. For instance, when breakfast rush is ongoing in New York, breakfast rush is commencing in Chicago, and before Chicago's breakfast is done, Denver breakfast begins, then New York lunch rush begins and so on across the nation and even other countries.

By way of example, if each AFPM can produce 20 orders in five minutes, then in one hour the maximum output of one AFPM would be 240 meals. If the typical morning breakfast in one time zone lasts two hours then a local AFPM can produce 480 breakfast meals at full capacity. If it takes an order taker, on the average, two and a half minutes to negotiate and activate an order, then it will take six hundred minutes of order taking time for the 480 breakfast meals. That is ten hours of order taking time which would require at least 5 order takers if the order taking were to keep up with one AFPM machine to produce all of these orders in two hours of time.

Assuming that the breakfast rush hour in a given time zone runs from 7:00 a.m. to 9:00 a.m. and the lunch rush hour in any time zone runs from 11:00 a.m. to 1:00 p.m. If one AFPM were operating in the eastern time zone (Washington, D.C., for example) of the United States, one AFPM in the central time zone (Chicago, Ill., for example), one AFPM in the mountain time zone (Denver, Colo., for example), and one AFPM in the Pacific time zone (Portland, Oreg., for example), the rush periods for breakfast and lunch throughout the four zones would extend over a nine hour period, with the first and last hours having limited demand and requiring only 5 order takers. To man these four AFPMs in each of the adjacent time zones with order takers, two shifts of 5 order takers working at maximum capacity would be required. Two shifts of five order takers each would have to be staggered one hour apart and therefore could both be working in one time zone with staggered start times, or each shift could start at the same time but in two adjacent time zones to achieve optimal utilization of manpower for receiving and entering the orders without excessive idle time.

Alternative technology is available in the form of a U.S. Patent Application No. 2003/0225622, filed by Doan on May 28, 2002. The Doan application discloses an idea for a restaurant in which customer's orders are taken over the phone by people who wanted to stay at home and work. The work at home person would send the customer's order back to the restaurant and into a POS or sales management system, so that other restaurant employees can take the order from the POS or sales management system and prepare the meal for the customer. The principal disadvantage of such a system is its costly next step requiring more onsite employees to process the order and prepare the meal.

Another possible solution to the problem of serial use of the advanced AFPM is to use multiple kiosks. These would be kiosks where the customer activates a touch screen, enters his menu selection, which in turn activates the AFPM. U.S. Pat. No. 6,415,555 teaches a kiosk system and method for accepting and processing customer orders and payments in a retail environment. There are many similar patents, all of which require the customer to learn some sort of program and then when the order is sent, it is sent to a sales management system like POS and then food service personnel prepare and deliver the customer's order. The primary problem with a kiosk solution whether used at a AFPM or a POS with food service personnel, is that customers inherently do not want to learn how to use it, they would rather an order taker take their order.

In an advanced AFPM that can simultaneously prepare and deliver about 20 meals for 20 different people in 5 minutes, the bottleneck is taking the customer's order. The solution of installing kiosks is a poor solution, because the customer wants to talk with a live human being, especially when the menu is complicated, as it is in the more advanced AFPM. The solution of adding more order taker is also not practical. It takes an order taker about 2½ minutes to take a customer's order. One would have to hire 10 order takers to take advantage of the speed of the advanced AFPM and with 10 order takers only effectively working during heavy traffic hours at breakfast, lunch and dinner, but still being paid for an 8-hour day, the economic advantages of an advanced AFPM would be lost.

So, there exists the problem of how to make use of the advanced AFPM speed without hiring 10 or more order takers or installing 20 non user-friendly kiosks.

The citation of the foregoing publications is not an admission that any particular publication constitutes prior art, or that any publication alone or in conjunction with others, renders unpatentable any pending claim of the present application. None of the cited publications is believed to detract from the patentability of the claimed invention.

### ADVANTAGES OF THIS INVENTION

Unlike the foregoing devices which teach the need to either use a kiosk system which requires the customer to learn to operate the kiosk system and deprives the customer of being able to discuss the order with a human being, or incur added employee costs for inefficient utilization of order takers and meal preparers, the systems and methods of the present invention allow a customer to discuss the food order with one of a group of human order takers who strategically work in staggered shifts to receive orders and activate a plurality of AFPMs efficiently reducing order taker downtime and effectively reduce or eliminate the need for meal preparers.

These together with other objects of the invention, along with the various features of novelty which characterize the invention are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

Still other advantages will be apparent from the disclosure that follows.

### SUMMARY OF THE INVENTION

The invention relates to a method of ordering at an Automated Food Processing Machine (AFPM) that has a plurality of at least one food item listed on a menu, means for storing the plurality of at least one food item listed on the menu, and means for receiving and preparing a remotely ordered food item, comprises establishing a first communication link that includes a voice communication link between the customer and a remote order taker, negotiating an order of a food item from the menu over the first communication link between the customer and the remote order taker, establishing a second communication link between the remote order taker and the AFPM, and remotely ordering the order of a food item over the second communication link by remotely activating the AFPM to prepare the ordered food item. In this way, a customer can communicate with a remote order taker to order a food item from the menu and the remote order taker can remotely activate the AFPM to prepare the ordered food item.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto. Those skilled in the art will appreciate that the conception upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWING

Preferred embodiments of the invention are described hereinafter with reference to the accompanying drawing wherein:

FIG. 1 is a flow diagram of a method of ordering at an Automated Food Processing Machine showing a remote communication with a broken line and local communication with a solid line;

FIG. 2 is a flow diagram of a method of ordering a food item by a plurality of customers at a plurality of Automated Food Processing Machines showing a remote communication with a broken line;

FIG. 3 is a schematic of a stand alone Automated Food Processing Machine restaurant showing a remote communication with a broken line;

FIG. 4 is a schematic of an Automated Food Processing Machine in the lobby of a hotel in communication with a plurality of remote order takers showing a remote communication with a broken line; and

FIG. 5 is a chart showing the succession of rush periods in adjacent time zones in which a plurality of Automated Food Processing Machines can be situated.

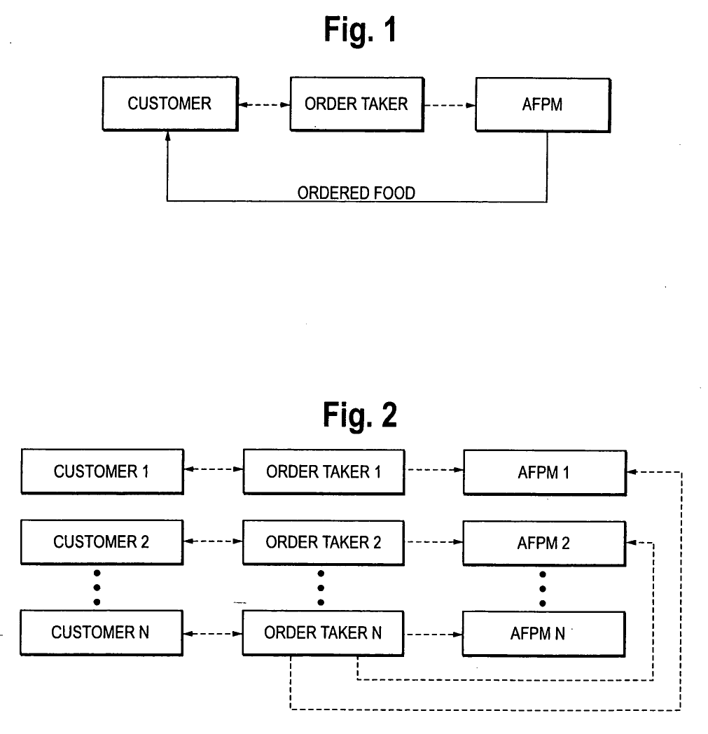

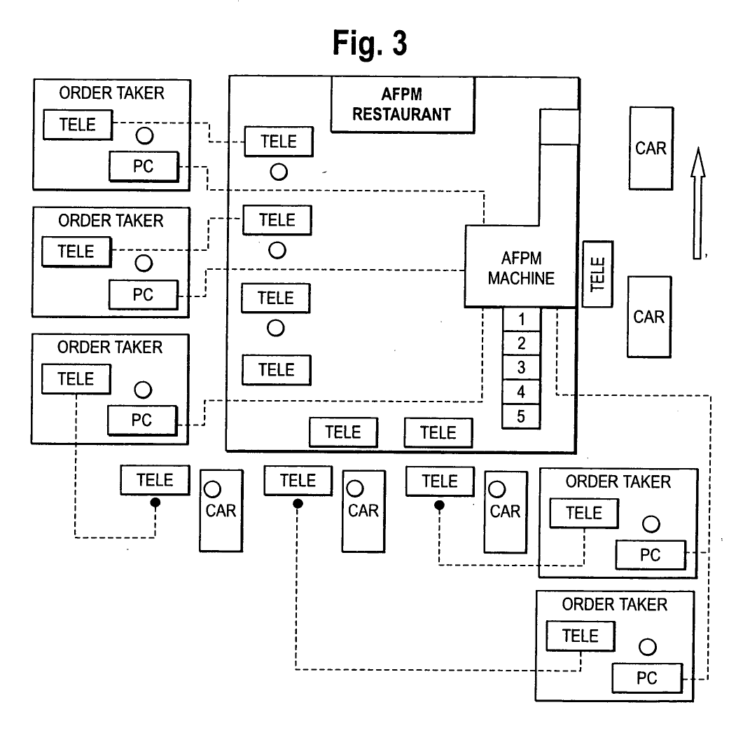

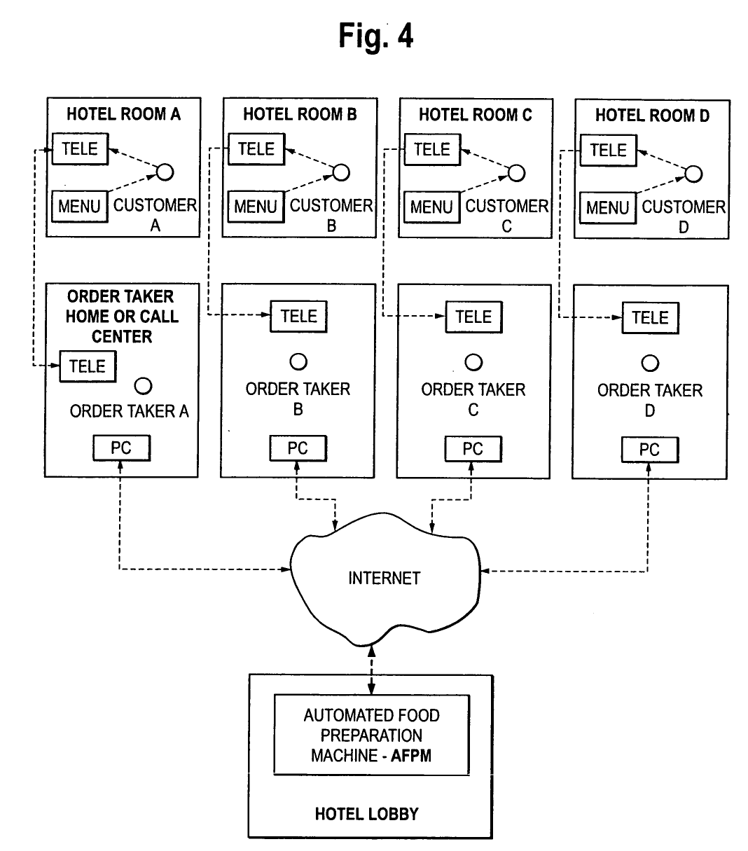

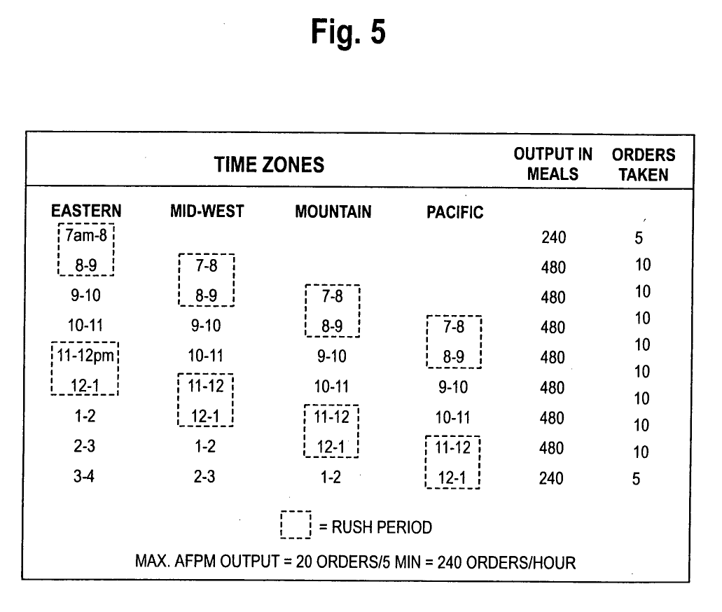

### DETAILED DESCRIPTION OF THE INVENTION

The invention relates to methods and systems for ordering at an Automated Food Processing Machine that has a plurality of at least one food item listed on a menu, means for storing the plurality of at least one food item listed on the menu, and means for receiving and preparing a remotely ordered food item. Without departing from the generality of the invention disclosed herein and without limiting the scope of the invention, the discussion that follows, will refer to the invention as depicted in the drawing.

The invention relates a method of ordering at an Automated Food Processing Machine (AFPM) that has a plurality of at least one food item listed on a menu, means for storing the plurality of at least one food item listed on the menu, and means for receiving and preparing a remotely ordered food item, comprises establishing a first communication link that includes a voice communication link between the customer and a remote order taker, negotiating an order of a food item from the menu over the first communication link between the customer and the remote order taker, establishing a second communication link between the remote order taker and the AFPM, and remotely ordering the order of a food item over the second communication link by remotely activating the AFPM to prepare the ordered food item. In this way, a customer can communicate with a remote order taker to order a food item from the menu and the remote order taker can remotely activate the AFPM to prepare the ordered food item. This method of ordering at an AFPM may further comprise the step of presenting the prepared food item to the customer.

Preferably, the step of remote ordering further includes remotely activating the AFPM to prepare the ordered food item independent of human intervention. The step of remote ordering further may also include remotely activating the AFPM to cook the ordered food item and produce a hot meal independent of human intervention.

The first communication link may include at least one of an ordinary telephone Public Switched Telephone Network (PSTN) and a Voice Over Internet Protocol (VoIP), especially for use with a stand-alone restaurant. The VoIP is a means of using the Internet to make a telephone call, bypassing the telephone company altogether. The order taker, and at times the customer, need special software and computer equipment.

The main advantages (VoIP) Voice over Internet Protocol are:

Order takers can be hired to work at home with their own computer and a high-speed Internet connection. This allows the system to accommodate telephone calls to and from the order taker's house and avoid paying the telephone company toll charges. Calls can be made internationally too, from Ireland, India and Australia where English speaking “order takers” are cheaper. The VoIP system would require a central server on the Internet where all the calls are routed through from around the world. The server “switches” calls from our many customers to the next available order taker, regardless of where the order taker or customer is located. All the order taker and customer need is a reasonably fast Internet connection like DSL or cable modem and a computer or a VoIP telephone device which allows for connection to the Internet.

The central server would allows our “telephone” order takers to log on and log off the network. Knowing which order takers are logged on or off means the order takers can work any hours that are convenient to them. In other words, once the order taker “logs off” then the server on the Internet will route no more calls to that order taker until logged back on again.

With a first communication link having both voice and data communication, order takers can show the customer the menu on a touch screen of a kiosk in the restaurant and talk to them at the same time. This provides an interactive multi-media communication session, which can be very user friendly and provide the customer with a short learning curve. Aafter several uses, the customer might learn how to use the system himself by watching what the order taker is doing on the screen while at the same time talking with the order taker. So, eventually the customer can take over the job of placing his order on a kiosk located in a stand-alone restaurant thus further reducing costs.

The time it takes to connect on a VoIP is much faster than dialing on a PSTN, so the customer is connected to an order taker in a couple seconds.

At peak times, if the order takers has logged off active service and has signed up to be on “stand-by” for higher pay, such order taker can be called up by the central server to see if they are willing to log back on and handle unexpected peak traffic—sort of a reserve army.

In a preferred embodiment of the method of ordering at an AFPM, the step of establishing the first communication link includes utilizing the voice communication link, and the step of negotiating an order of a food item from the menu includes orally communicating the order between the customer and the order taker. Moreover, the step of establishing the first communication link may include establishing a data link for at least one of communicating and acknowledging at least a part of the order of a food item from the menu.

Additionally, the step of establishing the second communication link may include establishing a data link over the Internet between the order taker and the AFPM, and the step of remote ordering may further include the remote order taker remotely activating the AFPM using the Internet. The step of negotiating each of a plurality of orders of food items from the menu from each of the plurality of customers over one of the plurality of first communication links is preferably carried out contemporaneously. Also, the step of negotiating each of a plurality of orders of food items from the menu from each of the plurality of customers over one of the plurality of first communication links may be carried out simultaneously.

The system for entering an order at an AFPM that has a plurality of at least one food item listed on a menu, means for storing the plurality of at least one food item listed on the menu, and means for receiving and preparing a remotely ordered food item, comprises a first communication link that includes a voice communication link between the customer and a remote order taker for negotiating an order of a food item from the menu over the first communication link between the customer and the remote order taker, and a second communication link between the remote order taker and the AFPM for remotely ordering the order of a food item by remotely activating the AFPM to prepare the ordered food item over the second communication link, so that a customer can communicate with a remote order taker to order a food item from the menu and the remote order taker can remotely activate the AFPM to prepare the ordered food item.

Additionally, the voice communication link may allow the food item to be ordered orally between the customer and the order taker. Also, the data link may provide for at least a part of the order of a food item from the menu to be communicated digitally. The data link may be routed over the Internet between the order taker and the AFPM, so that the AFPM can be remotely activated by the remote order taker using the Internet. Preferably, each of a plurality of orders of food items from the menu from each of the plurality of customers over one of the plurality of first communication links is carried out contemporaneously or simultaneously.

The AFPM may be remotely activated to prepare the ordered food item independent of human intervention; the AFPM may be remotely activated to cook the ordered food item and produce a hot meal independent of human intervention.

A method of this important invention for ordering at an AFPM that has a plurality of at least one food item listed on a menu, means for storing the plurality of at least one food item listed on the menu, and means for contemporaneously receiving and contemporaneously preparing a plurality of remotely ordered food items, comprises establishing a plurality of first communication links that include a voice communication link between each of a plurality of customers and each one of a plurality of remote order takers, negotiating each of a plurality of orders of food items from the menu from each of the plurality of customers over one of the plurality of first communication links, establishing a plurality of second communication links between each of the plurality of remote order takers and the AFPM, remotely ordering each of the plurality of ordered food items over one of the plurality of the second communication links by remotely activating the AFPM to prepare each of the plurality of ordered food items.

Whereby, each of the plurality of customers can contemporaneously communicate with one of the plurality of remote order takers to order a food item from the menu and each of the remote order takers can remotely activate the AFPM to contemporaneously prepare the ordered food items.

A system for ordering at an AFPM that has a plurality of at least one food item listed on a menu, means for storing the plurality of at least one food item listed on the menu, and means for contemporaneously receiving and contemporaneously preparing a plurality of remotely ordered food items is also taught by the present invention. It comprises a plurality of first communication links that include a voice communication link between each of a plurality of customers and each one of a plurality of remote order takers for negotiating each of a plurality of orders of food items from the menu from each of the plurality of customers over one of the plurality of first communication links, and a plurality of second communication links between each of the plurality of remote order takers and the AFPM for remotely ordering each of the plurality of ordered food items over one of the plurality of the second communication links by remotely activating the AFPM to prepare each of the plurality of ordered food items, so that each of the plurality of customers can contemporaneously communicate with one of the plurality of remote order takers to order a food item from the menu and each of the remote order takers can remotely activate the AFPM to contemporaneously prepare the ordered food items.

Another method of ordering at one of a plurality of AFPMs that each has a plurality of at least one food item listed on a menu which is accessible to a plurality of local customers situated proximate to a local AFPM which is one of the plurality of AFPMs, means for storing the plurality of the at least one food item listed on the menu, and means for contemporaneously receiving and contemporaneously preparing a plurality of remotely ordered food items, includes establishing a plurality of first communication links that each include a voice communication link between each of the plurality of local customers and one of a plurality of remote order takers, negotiating each of a plurality of orders of food items from the menu of at least one of the local AFPM from each of the plurality of local customers over one of the plurality of first communication links, establishing a plurality of second communication links between each of the plurality of remote order takers that has negotiated one of the plurality of orders of food items from the menu that was accessible to each of the plurality of local customers placing the order and each of the local AFPM situated proximate to each of the plurality of local customers, remotely ordering each of the plurality of ordered food items over one of the plurality of second communication links by remotely activating each of the local AFPM situated proximate to each of the plurality of local customers that placed the order to prepare each of the plurality of ordered food items.

Whereby, each of the plurality of local customers can communicate with one of the plurality of remote order takers to order a food item from the menu accessible to the customer and each of the remote order takers can remotely activate each of the local AFPM to prepare the ordered food items. Furthermore, the step of remotely ordering each of the plurality of ordered food items over one of the second communication links by remotely activating the AFPM to prepare each of the plurality of ordered food items may be carried out contemporaneously, the step of negotiating each of a plurality of orders of food items from the menu from each of the plurality of customers over one of the plurality of first communication links may also be carried out contemporaneously or simultaneously.

Additionally, the step of establishing a plurality of first communication links between each of a plurality of customers and one of a plurality of remote order takers may include at least one of the plurality of customers being situated in a first time zone that is different from another time zone in which another one of the plurality of customers is situated.

The system for ordering at one of a plurality of Automated Food Processing Machines associated with the foregoing method comprises a plurality of first communication links that each include a voice communication link between each of the plurality of local customers and one of a plurality of remote order takers for negotiating each of a plurality of orders of food items from the menu of at least one of the local AFPM from each of the plurality of local customers over one of the plurality of first communication links, and a plurality of second communication links between each of the plurality of remote order takers that has negotiated one of the plurality of orders of food items from the menu that was accessible to each of the plurality of local customers placing the order and each of the local AFPM situated proximate to each of the plurality of local customers for remotely ordering each of the plurality of ordered food items over one of the plurality of second communication links by remotely activating each of the local AFPM situated proximate to each of the plurality of local customers that placed the order to prepare each of the plurality of ordered food items, so that each of the plurality of local customers can communicate with one of the plurality of remote order takers to order a food item from the menu accessible to the customer and each of the remote order takers can remotely activate each of the local AFPM to prepare the ordered food items.

In a preferred embodiment of the system, each of the plurality of ordered food items ordered remotely over one of the second communication links by remotely activating the AFPM to prepare each of the plurality of ordered food items is carried out contemporaneously. Also, each of a plurality of orders of food items from the menu from each of the plurality of customers over one of the plurality of first communication links may be carried out contemporaneously or simultaneously. Furthermore, the plurality of first communication links between each of the plurality of customers and one of a plurality of remote order takers may include at least one of the plurality of customers being situated in a first time zone that is different from another time zone in which another one of the plurality of customers is situated.

Another preferred method of ordering at one of a plurality of Automated Food Processing Machines that are located in a plurality of time zones, each of the plurality of AFPMs has a plurality of at least one food item listed on a local menu which is accessible to a local customer situated in one of the plurality of time zones proximate to a local AFPM which is one of the plurality of AFPMs, means for storing the plurality of the at least one food item listed on the menu, and means for contemporaneously receiving and contemporaneously preparing a plurality of remotely ordered food items, comprises establishing a plurality of first communication links that each include a voice communication link between each of a plurality of local customers and one of a plurality of remote order takers, negotiating each of a plurality of orders of food items from one of the local menus from each of the plurality of local customers situated in one of the plurality of time zones over one of the plurality of first communication links, establishing a plurality of second communication links between each of the plurality of remote order takers that has negotiated one of the plurality of orders of food items from the menu that was accessible to the local customer placing the order and the local AFPM situated proximate to the local customer, remotely ordering each of the plurality of ordered food items over one of the plurality of second communication links by each of the remote order takers remotely activating the local AFPM situated proximate to the local customer that placed the order to prepare one of the plurality of ordered food items.

Whereby, each of the local customers situated in one of the plurality of time zones can communicate with one of the plurality of remote order takers to order a food item from the menu accessible to the customer and each of the remote order takers can remotely activate the local AFPM situated proximate to the local customer that placed the order to prepare the ordered food items.

The step of establishing a plurality of first communication links between each of a plurality of customers situated in one of the plurality of time zones and one of a plurality of remote order takers may include situating the plurality of remote order takers in a plurality of time zones, each of the plurality of time zones having at least one shift of remote order takers operating during at least one predetermined time interval, each at least one shift starting at a predetermined similar local time, so that the starting time of the at least one shift in a first time zone is staggered relative to the starting time of a shift in another time zone, so that the at least one shift of remote order takers in one of the plurality of time zones can support another shift of remote order takers in another of the plurality of time zones to efficiently activate the plurality of AFPMs to contemporaneously receive and contemporaneously prepare the plurality of remotely ordered food items.

Additionally, the step of negotiating each of a plurality of orders of food items can be optimized during a rush period in which an above average number of the plurality of orders are generated from the plurality of local customers situated in one of the plurality of time zones by negotiating during the rush period the plurality of orders of food items from the menu from each of the plurality of local customers situated in one of the plurality of time zones to the plurality of order takers situated in more than one time zone, so that the above average number of the plurality of orders generated from the plurality of local customers situated in one of the plurality of time zones during the rush period can be negotiated with the plurality of order takers situated in more than one time zone, some of which may not be experiencing a rush period from local customers in the time zone in which some of the plurality of order takers are situated to efficiently smooth out the number of the plurality of orders each order taker is required to take in a given time period.

A system for ordering at one of a plurality of Automated Food Processing Machines that are located in a plurality of time zones, each of the plurality of AFPMs has a plurality of at least one food item listed on a local menu which is accessible to a local customer situated in one of the plurality of time zones proximate to a local AFPM which is one of the plurality of AFPMs, means for storing the plurality of the at least one food item listed on the menu, and means for contemporaneously receiving and contemporaneously preparing a plurality of remotely ordered food items, in accordance with the foregoing methods may comprise a plurality of first communication links that each include a voice communication link between each of a plurality of local customers and one of a plurality of remote order takers for negotiating each of a plurality of orders of food items from one of the local menus from each of the plurality of local customers situated in one of the plurality of time zones over one of the plurality of first communication links, and a plurality of second communication links between each of the plurality of remote order takers that has negotiated one of the plurality of orders of food items from the menu that was accessible to the local customer placing the order and the local AFPM situated proximate to the local customer for remotely ordering each of the plurality of ordered food items over one of the plurality of second communication links by each of the remote order takers remotely activating the local AFPM situated proximate to the local customer that placed the order to prepare one of the plurality of ordered food items, so that each of the local customers situated in one of the plurality of time zones can communicate with one of the plurality of remote order takers to order a food item from the menu accessible to the customer and each of the remote order takers can remotely activate the local AFPM situated proximate to the local customer that placed the order to prepare the ordered food items.

The plurality of first communication links between each of a plurality of customers situated in one of the plurality of time zones and one of a plurality of remote order takers may further include situating the plurality of remote order takers in a plurality of time zones, each of the plurality of time zones having at least one shift of remote order takers operating during at least one predetermined time interval, each at least one shift starting at a predetermined similar local time, so that the starting time of the at least one shift in a first time zone is staggered relative to the starting time of a shift in another time zone. In this way, the at least one shift of remote order takers in one of the plurality of time zones can support another shift of remote order takers in another of the plurality of time zones to efficiently activate the plurality of AFPMs to contemporaneously receive and contemporaneously prepare the plurality of remotely ordered food items.

Additionally, each of a plurality of orders of food items may be optimized during a rush period in which an above average number of the plurality of orders are generated from the plurality of local customers situated in one of the plurality of time zones by negotiating during the rush period the plurality of orders of food items from the menu from each of the plurality of local customers situated in one of the plurality of time zones to the plurality of order takers situated in more than one time zone, so that the above average number of the plurality of orders generated from the plurality of local customers situated in one of the plurality of time zones during the rush period can be negotiated with the plurality of order takers situated in more than one time zone, some of which may not be experiencing a rush period from local customers in the time zone in which some of the plurality of order takers are situated to efficiently smooth out the number of the plurality of orders each order taker is required to take in a given time period.

A method taught by the present invention of optimizing ordering during a rush period at a plurality of Automated Food Processing Machines (AFPMs) that are located in a plurality of time zones, each AFPM has a plurality of at least one food item listed on a menu accessible to a local customer situated in one of the plurality of time zones proximate to a local AFPM which is one of the plurality of AFPMs, means for storing the plurality of the at least one food item listed on the menu, and means for contemporaneously receiving and contemporaneously preparing an optimal number of remotely ordered food items that can each be prepared in a predetermined preparation time period, comprises establishing a plurality of first communication links that each include a voice communication link between each of the plurality of local customers situated in each of the plurality of time zones and one of a plurality of remote order takers, the plurality of remote order takers being sufficient in number and availability to maximize the number of food items that can be prepared by each AFPM during the rush period, the availability being enhanced by situating the plurality of remote order takers in a plurality of time zones, negotiating during the rush period each of a plurality of orders of food items from the menu over a period of time averaging less time than the predetermined preparation time period from each of the plurality of customers situated in one of the plurality of time zones over one of the plurality of first communication links, establishing a sufficient number of second communication links between each of the plurality of remote order takers that has negotiated one of the plurality of orders of food items from the menu that was accessible to the local customer placing the order and the local AFPM situated proximate to the local customer, remotely ordering each of the plurality of ordered food items over one of the plurality of second communication links by remotely activating the local AFPM situated proximate to the local customer that placed the order to prepare each of the plurality of ordered food items contemporaneously.

Whereby, each of the local customers situated in one of the plurality of time zones can communicate with one of the plurality of remote order takers to order a food item from the menu accessible to the customer and each of the remote order takers can remotely activate the local AFPM proximate to the customer to prepare the ordered food items unconsecutively.

Preferably, the step of establishing the plurality of first communication links between each of the plurality of customers situated in each of the plurality of time zones and each one of a plurality of remote order takers includes the plurality of customers situated in an adjacent plurality of time zones.

A system associated with the foregoing methods for optimizing ordering during a rush period at a plurality of Automated Food Processing Machines (AFPMs) that are located in a plurality of time zones, each AFPM has a plurality of at least one food item listed on a menu accessible to a local customer situated in one of the plurality of time zones proximate to a local AFPM which is one of the plurality of AFPMs, means for storing the plurality of the at least one food item listed on the menu, and means for contemporaneously receiving and contemporaneously preparing an optimal number of remotely ordered food items that can each be prepared in a predetermined preparation time period, comprises a plurality of first communication links that each include a voice communication link between each of the plurality of local customers situated in each of the plurality of time zones and one of a plurality of remote order takers, the plurality of remote order takers being sufficient in number and availability to maximize the number of food items that can be prepared by each AFPM during the rush period, the availability being enhanced by situating the plurality of remote order takers in a plurality of time zones for negotiating during the rush period each of a plurality of orders of food items from the menu over a period of time averaging less time than the predetermined preparation time period from each of the plurality of customers situated in one of the plurality of time zones over one of the plurality of first communication links, and a sufficient number of second communication links between each of the plurality of remote order takers that has negotiated one of the plurality of orders of food items from the menu that was accessible to the local customer placing the order and the local AFPM situated proximate to the local customer for remotely ordering each of the plurality of ordered food items over one of the plurality of second communication links by remotely activating the local AFPM situated proximate to the local customer that placed the order to prepare each of the plurality of ordered food items contemporaneously.

In this way, each of the local customers situated in one of the plurality of time zones can communicate with one of the plurality of remote order takers to order a food item from the menu accessible to the customer and each of the remote order takers can remotely activate the local AFPM proximate to the customer to prepare the ordered food items unconsecutively.

The plurality of first communication links between each of the plurality of customers situated in each of the plurality of time zones and each one of a plurality of remote order takers may also include the plurality of customers situated in an adjacent plurality of time zones.

A preferred method of optimizing the use of a plurality of remote order takers during rush periods for negotiating orders at a plurality of Automated Food Processing Machines that are located in a plurality of adjacent time zones, each of the plurality of AFPMs has a plurality of at least one food item listed on a local menu which is accessible to a local customer situated in one of the first plurality of time zones proximate to a local AFPM which is one of the plurality of AFPMs, means for storing the plurality of the at least one food item listed on the menu, and means for contemporaneously receiving and contemporaneously preparing a plurality of remotely ordered food items, includes:
a. establishing at least two shifts of remote order takers, each of the shifts starting to take orders at a different time,
b. establishing a plurality of first communication links that each include a voice communication link between each of a plurality of local customers and an available one of the at least two groups of remote order takers for taking orders during rush periods, including at least one of a breakfast rush period in the morning, a lunch rush period in the mid-day, and a dinner rush period in the evening in each of the plurality of adjacent time zones in which the plurality of AFPMs are located, wherein the breakfast rush period of a first adjacent time zone commences before the breakfast rush period of a second adjacent time zone and the breakfast rush period of the first adjacent time zone generally ends after the breakfast rush period of the second adjacent time zone commences, so that the breakfast rush period of a number of adjacent time zones will commence with the breakfast rush period of the first adjacent time zone and continue until the breakfast rush period of the last of the number of adjacent time zones ends, wherein the lunch rush period of the first adjacent time zone commences before the lunch rush period of the second adjacent time zone and the lunch rush period of the first adjacent time zone generally ends after the lunch rush period of the second adjacent time zone commences, so that the lunch rush period of a number of adjacent time zones will commence with the lunch rush period of the first adjacent time zone and continue until the lunch rush period of the last of the number of adjacent time zones ends, and wherein a dinner rush period of the first adjacent time zone commences before the dinner rush period of the second adjacent time zone and the dinner rush period of the first adjacent time zone generally ends after the dinner rush period of the second adjacent time zone commences, so that the dinner rush period of a number of adjacent time zones will commence with the dinner rush period of the first adjacent time zone and continue until the dinner rush period of the last of the number of adjacent time zones ends, and wherein at least one of (I) the breakfast rush period of the number of adjacent time zones and the lunch rush period of the number of adjacent time zones and (ii) the lunch rush period of the number of adjacent time zones and the dinner rush period of the number of adjacent time zones overlap, so that the rush periods of the number of adjacent time zones in which an above average number of the plurality of orders are generated from the plurality of local customers situated in the respective adjacent plurality of time zones extend substantially throughout the at least two shifts of remote order takers,
c. negotiating each of a plurality of orders of food items from one of the local menus from each of the plurality of local customers situated in one of the plurality of adjacent time zones over one of the plurality of first communication links,
d. establishing a plurality of second communication links between each of the plurality of remote order takers that has negotiated one of the plurality of orders of food items from the menu that was accessible to the local customer placing the order and the local AFPM situated proximate to the local customer,
e. remotely ordering each of the plurality of ordered food items over one of the plurality of second communication links by each of the remote order takers remotely activating the local AFPM situated proximate to the local customer that placed the order to prepare one of the plurality of ordered food items.

In this method, each of the at least two shifts of remote order takers can support the other of the at least two shifts of remote order takers to efficiently negotiate orders and activate one of the plurality of AFPMs during rush periods in a number of adjacent time zones independent of substantial idle time intervals during the at least two shifts of remote order takers.

While this invention has been described in connection with the best mode presently contemplated by the inventor for carrying out his invention, the preferred embodiments described and shown are for purposes of illustration only, and are not to be construed as constituting any limitations of the invention. Modifications will be obvious to those skilled in the art, and all modifications that do not depart from the spirit of the invention are intended to be included within the scope of the appended claims. Those skilled in the art will appreciate that the conception upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

My invention resides not in any one of these features per se, but rather in the particular combinations of some or all of them herein disclosed and claimed and it is distinguished from the prior art in these particular combinations of some or all of its structures for the functions specified.

With respect to the above description then, it is to be realized that the optimum dimensional relationships for the parts of the invention, including variations in size, materials, shape, form, function and manner of operation, assembly and use, and all equivalent relationships to those illustrated in the drawings and described in the specification, that would be deemed readily apparent and obvious to one skilled in the art, are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A method of ordering at an Automated Food Processing Machine (AFPM) that has a plurality of at least one food item listed on a menu, means for storing the plurality of at least one food item listed on the menu, and means for receiving and preparing a remotely ordered food item, comprising:
a. establishing a first communication link that includes a voice communication link between the customer and a remote order taker;
b. negotiating an order of a food item from the menu over the first communication link between the customer and the remote order taker;
c. establishing a second communication link between the remote order taker and the AFPM;
d. remotely ordering the order of a food item over the second communication link by remotely activating the AFPM to prepare the ordered food item,
whereby, a customer can communicate with a remote order taker to order a food item from the menu and the remote order taker can remotely activate the AFPM to prepare the ordered food item.

2. The method of ordering at an AFPM of claim 1, wherein the step of remote ordering further includes remotely activating the AFPM to prepare the ordered food item independent of human intervention.

3. The method of ordering at an AFPM of claim 1, wherein the step of remote ordering further includes remotely activating the AFPM to cook the ordered food item and produce a hot meal independent of human intervention.

4. The method of ordering at an AFPM of claim 1, wherein the step of establishing the first communication link includes utilizing the voice communication link, and the step of negotiating an order of a food item from the menu includes orally communicating the order between the customer and the order taker.

5. The method of ordering at an AFPM of claim 1, wherein the step of establishing the first communication link includes establishing a data link for at least one of communicating and acknowledging at least a part of the order of a food item from the menu.

6. The method of ordering at an AFPM of claim 1, wherein the step of establishing the second communication link includes establishing a data link over the Internet between the order taker and the AFPM, and the step of remote ordering further includes the remote order taker remotely activating the AFPM using the Internet.

7. The method of ordering at an AFPM of claim 6, wherein the step of negotiating each of a plurality of orders of food items from the menu from each of the plurality of customers over one of the plurality of first communication links is carried out contemporaneously.

8. The method of ordering at an AFPM of claim 7, wherein the step of negotiating each of a plurality of orders of food items from the menu from each of the plurality of customers over one of the plurality of first communication links is carried out simultaneously.

9. The method of ordering at an AFPM of claim 1, further comprising the step of presenting the prepared food item to the customer.

10. A system for entering an order at an Automated Food Processing Machine (AFPM) that has a plurality of at least one food item listed on a menu, means for storing the plurality of at least one food item listed on the menu, and means for receiving and preparing a remotely ordered food item, comprising:
a. a first communication link that includes a voice communication link between the customer and a remote order taker for negotiating an order of a food item from the menu over the first communication link between the customer and the remote order taker;
b. a second communication link between the remote order taker and the AFPM for remotely ordering the order of a food item by remotely activating the AFPM to prepare the ordered food item over the second communication link,
whereby, a customer can communicate with a remote order taker to order a food item from the menu and the remote order taker can remotely activate the AFPM to prepare the ordered food item.

11. The system for ordering at an AFPM of claim 10, wherein the AFPM is remotely activating to prepare the ordered food item independent of human intervention.

12. The system for ordering at an AFPM of claim 10, wherein the AFPM is remotely activating to cook the ordered food item and produce a hot meal independent of human intervention.

13. The system for ordering at an AFPM of claim 10, wherein the voice communication link allows the food item to be ordered orally between the customer and the order taker.

14. The system for ordering at an AFPM of claim 10, wherein the data link provides for at least a part of the order of a food item from the menu to be communicated digitally.

15. The system for ordering at an AFPM of claim 10, wherein the data link is routed over the Internet between the order taker and the AFPM, and the AFPM is remotely activated by the remote order taker using the Internet.

16. The system for ordering at an AFPM of claim 15, wherein each of a plurality of orders of food items from the menu from each of the plurality of customers over one of the plurality of first communication links is carried out contemporaneously.

17. The system for ordering at an AFPM of claim 16, wherein each of a plurality of orders of food items from the menu from each of the plurality of customers over one of the plurality of first communication links is carried out simultaneously.

18. A method of ordering at an Automated Food Processing Machine (AFPM) that has a plurality of at least one food item listed on a menu, means for storing the plurality of at least one food item listed on the menu, and means for contemporaneously receiving and contemporaneously preparing a plurality of remotely ordered food items, comprising:
a. establishing a plurality of first communication links that include a voice communication link between each of a plurality of customers and each one of a plurality of remote order takers;
b. negotiating each of a plurality of orders of food items from the menu from each of the plurality of customers over one of the plurality of first communication links;
c. establishing a plurality of second communication links between each of the plurality of remote order takers and the AFPM;
d. remotely ordering each of the plurality of ordered food items over one of the plurality of the second communication links by remotely activating the AFPM to prepare each of the plurality of ordered food items,
whereby, each of the plurality of customers can contemporaneously communicate with one of the plurality of remote order takers to order a food item from the menu and each of the remote order takers can remotely activate the AFPM to contemporaneously prepare the ordered food items.

19. A system for ordering at an Automated Food Processing Machine (AFPM) that has a plurality of at least one food item listed on a menu, means for storing the plurality of at least one food item listed on the menu, and means for contemporaneously receiving and contemporaneously preparing a plurality of remotely ordered food items, comprising:
a. a plurality of first communication links that include a voice communication link between each of a plurality of customers and each one of a plurality of remote order takers for negotiating each of a plurality of orders of food items from the menu from each of the plurality of customers over one of the plurality of first communication links; and
b. a plurality of second communication links between each of the plurality of remote order takers and the AFPM for remotely ordering each of the plurality of ordered food items over one of the plurality of the second communication links by remotely activating the AFPM to prepare each of the plurality of ordered food items,
whereby, each of the plurality of customers can contemporaneously communicate with one of the plurality of remote order takers to order a food item from the menu and each of the remote order takers can remotely activate the AFPM to contemporaneously prepare the ordered food items.

20. A method of ordering at one of a plurality of Automated Food Processing Machines (AFPMs) that each has a plurality of at least one food item listed on a menu which is accessible to a plurality of local customers situated proximate to a local AFPM which is one of the plurality of AFPMs, means for storing the plurality of the at least one food item listed on the menu, and means for contemporaneously receiving and contemporaneously preparing a plurality of remotely ordered food items, comprising:
a. establishing a plurality of first communication links that each include a voice communication link between each of the plurality of local customers and one of a plurality of remote order takers;
b. negotiating each of a plurality of orders of food items from the menu of at least one of the local AFPM from each of the plurality of local customers over one of the plurality of first communication links;
c. establishing a plurality of second communication links between each of the plurality of remote order takers that has negotiated one of the plurality of orders of food items from the menu that was accessible to each of the plurality of local customers placing the order and each of the local AFPM situated proximate to each of said plurality of local customers;
d. remotely ordering each of the plurality of ordered food items over one of the plurality of second communication links by remotely activating each of the local AFPM situated proximate to each of plurality of local customers that placed the order to prepare each of the plurality of ordered food items,
whereby, each of plurality of local customers can communicate with one of the plurality of remote order takers to order a food item from the menu accessible to said customer and each of the remote order takers can remotely activate each of the local AFPM to prepare the ordered food items.

21. The method of ordering at an AFPM of claim 20, wherein the step of remotely ordering each of the plurality of ordered food items over one of the second communication links by remotely activating the AFPM to prepare each of the plurality of ordered food items is carried out contemporaneously.

22. The method of ordering at an AFPM of claim 21, wherein the step of negotiating each of a plurality of orders of food items from the menu from each of the plurality of customers over one of the plurality of first communication links is carried out contemporaneously.

23. The method of ordering at an AFPM of claim 22, wherein the step of negotiating each of a plurality of orders of food items from the menu from each of the plurality of customers over one of the plurality of first communication links is carried out simultaneously.

24. The method of ordering at an AFPM of claim 21, wherein the step of establishing a plurality of first communication links between each of a plurality of customers and one of a plurality of remote order takers includes at least one of the plurality of customers being situated in a first time zone that is different from another time zone in which another one of the plurality of customers is situated.

25. A system for ordering at one of a plurality of Automated Food Processing Machines (AFPMs) that each has a plurality of at least one food item listed on a menu which is accessible to a plurality of local customers situated proximate to a local AFPM which is one of the plurality of AFPMs, means for storing the plurality of the at least one food item listed on the menu, and means for contemporaneously receiving and contemporaneously preparing a plurality of remotely ordered food items, comprising:
a. a plurality of first communication links that each include a voice communication link between each of the plurality of local customers and one of a plurality of remote order takers for negotiating each of a plurality of orders of food items from the menu of at least one of the local AFPM from each of the plurality of local customers over one of the plurality of first communication links; and
b. a plurality of second communication links between each of the plurality of remote order takers that has negotiated one of the plurality of orders of food items from the menu that was accessible to each of the plurality of local customers placing the order and each of the local AFPM situated proximate to each of said plurality of local customers for remotely ordering each of the plurality of ordered food items over one of the plurality of second communication links by remotely activating each of the local AFPM situated proximate to each of plurality of local customers that placed the order to prepare each of the plurality of ordered food items,
whereby, each of the plurality of local customers can communicate with one of the plurality of remote order takers to order a food item from the menu accessible to said customer and each of the remote order takers can remotely activate each of the local AFPM to prepare the ordered food items.

26. The system for ordering at an AFPM of claim 25, each of the plurality of ordered food items ordered remotely over one of the second communication links by remotely activating the AFPM to prepare each of the plurality of ordered food items is carried out contemporaneously.

27. The system for ordering at an AFPM of claim 26, wherein each of a plurality of orders of food items from the menu from each of the plurality of customers over one of the plurality of first communication links is carried out contemporaneously.

28. The system for ordering at an AFPM of claim 27, wherein each of a plurality of orders of food items from the menu from each of the plurality of customers over one of the plurality of first communication links is carried out simultaneously.

29. The system for ordering at an AFPM of claim 26, wherein the plurality of first communication links between each of the plurality of customers and one of a plurality of remote order takers includes at least one of the plurality of customers being situated in a first time zone that is different from another time zone in which another one of the plurality of customers is situated.

30. A method of ordering at one of a plurality of Automated Food Processing Machines (AFPMs) that are located in a plurality of time zones, each of the plurality of AFPMs has a plurality of at least one food item listed on a local menu which is accessible to a local customer situated in one of the plurality of time zones proximate to a local AFPM which is one of the plurality of AFPMs, means for storing the plurality of the at least one food item listed on the menu, and means for contemporaneously receiving and contemporaneously preparing a plurality of remotely ordered food items, comprising:
a. establishing a plurality of first communication links that each include a voice communication link between each of a plurality of local customers and one of a plurality of remote order takers;
b. negotiating each of a plurality of orders of food items from one of the local menus from each of the plurality of local customers situated in one of the plurality of time zones over one of the plurality of first communication links;
c. establishing a plurality of second communication links between each of the plurality of remote order takers that has negotiated one of the plurality of orders of food items from the menu that was accessible to the local customer placing the order and the local AFPM situated proximate to said local customer;
d. remotely ordering each of the plurality of ordered food items over one of the plurality of second communication links by each of the remote order takers remotely activating the local AFPM situated proximate to the local customer that placed the order to prepare one of the plurality of ordered food items,
whereby, each of the local customers situated in one of the plurality of time zones can communicate with one of the plurality of remote order takers to order a food item from the menu accessible to said customer and each of the remote order takers can remotely activate the local AFPM situated proximate to the local customer that placed the order to prepare the ordered food items.

31. The method of ordering at an AFPM of claim 30, wherein the step of establishing a plurality of first communication links between each of a plurality of customers situated in one of the plurality of time zones and one of a plurality of remote order takers includes situating the plurality of remote order takers in a plurality of time zones, each of said plurality of time zones having at least one shift of remote order takers operating during at least one predetermined time interval, each at least one shift starting at a predetermined similar local time, so that the starting time of the at least one shift in a first time zone is staggered relative to the starting time of a shift in another time zone,
whereby, the at least one shift of remote order takers in one of the plurality of time zones can support another shift of remote order takers in another of the plurality of time zones to efficiently activate the plurality of AFPMs to contemporaneously receive and contemporaneously prepare the plurality of remotely ordered food items.

32. The method of ordering at an AFPM of claim 31, wherein the step of negotiating each of a plurality of orders of food items can be optimized during a rush period in which an above average number of the plurality of orders are generated from the plurality of local customers situated in one of the plurality of time zones by negotiating during the rush period the plurality of orders of food items from the menu from each of the plurality of local customers situated in one of the plurality of time zones to the plurality of order takers situated in more than one time zone,
whereby, the above average number of the plurality of orders generated from the plurality of local customers situated in one of the plurality of time zones during the rush period can be negotiated with the plurality of order takers situated in more than one time zone, some of which may not be experiencing a rush period from local customers in the time zone in which some of the plurality of order takers are situated to efficiently smooth out the number of the plurality of orders each order taker is required to take in a given time period.

33. A system for ordering at one of a plurality of Automated Food Processing Machines (AFPMs) that are located in a plurality of time zones, each of the plurality of AFPMs has a plurality of at least one food item listed on a local menu which is accessible to a local customer situated in one of the plurality of time zones proximate to a local AFPM which is one of the plurality of AFPMs, means for storing the plurality of the at least one food item listed on the menu, and means for contemporaneously receiving and contemporaneously preparing a plurality of remotely ordered food items, comprising:
a. a plurality of first communication links that each include a voice communication link between each of a plurality of local customers and one of a plurality of remote order takers for negotiating each of a plurality of orders of food items from one of the local menus from each of the plurality of local customers situated in one of the plurality of time zones over one of the plurality of first communication links; and
b. a plurality of second communication links between each of the plurality of remote order takers that has negotiated one of the plurality of orders of food items from the menu that was accessible to the local customer placing the order and the local AFPM situated proximate to said local customer for remotely ordering each of the plurality of ordered food items over one of the plurality of second communication links by each of the remote order takers remotely activating the local AFPM situated proximate to the local customer that placed the order to prepare one of the plurality of ordered food items,
whereby, each of the local customers situated in one of the plurality of time zones can communicate with one of the plurality of remote order takers to order a food item from the menu accessible to said customer and each of the remote order takers can remotely activate the local AFPM situated proximate to the local customer that placed the order to prepare the ordered food items.

34. The system for ordering at an AFPM of claim 33, wherein the plurality of first communication links between each of a plurality of customers situated in one of the plurality of time zones and one of a plurality of remote order takers includes situating the plurality of remote order takers in a plurality of time zones, each of said plurality of time zones having at least one shift of remote order takers operating during at least one predetermined time interval, each at least one shift starting at a predetermined similar local time, so that the starting time of the at least one shift in a first time zone is staggered relative to the starting time of a shift in another time zone,
whereby, the at least one shift of remote order takers in one of the plurality of time zones can support another shift of remote order takers in another of the plurality of time zones to efficiently activate the plurality of AFPMs to contemporaneously receive and contemporaneously prepare the plurality of remotely ordered food items.

35. The system for ordering at an AFPM of claim 34, wherein the each of a plurality of orders of food items can be optimized during a rush period in which an above average number of the plurality of orders are generated from the plurality of local customers situated in one of the plurality of time zones by negotiating during the rush period the plurality of orders of food items from the menu from each of the plurality of local customers situated in one of the plurality of time zones to the plurality of order takers situated in more than one time zone,
whereby, the above average number of the plurality of orders generated form the plurality of local customers situated in one of the plurality of time zones during the rush period can be negotiated with the plurality of order takers situated in more than one time zone, some of which may not be experiencing a rush period from local customers in the time zone in which some of the plurality of order takers are situated to efficiently smooth out the number of the plurality of orders each order taker is required to take in a given time period.

36. A method of optimizing ordering during a rush period at a plurality of Automated Food Processing Machines (AFPMs) that are located in a plurality of time zones, each AFPM has a plurality of at least one food item listed on a menu accessible to a local customer situated in one of the plurality of time zones proximate to a local AFPM which is one of the plurality of AFPMs, means for storing the plurality of the at least one food item listed on the menu, and means for contemporaneously receiving and contemporaneously preparing an optimal number of remotely ordered food items that can each be prepared in a predetermined preparation time period, comprising:
a. establishing a plurality of first communication links that each include a voice communication link between each of the plurality of local customers situated in each of the plurality of time zones and one of a plurality of remote order takers, said plurality of remote order takers being sufficient in number and availability to maximize the number of food items that can be prepared by each AFPM during the rush period, said availability being enhanced by situating the plurality of remote order takers in a plurality of time zones;
b. negotiating during the rush period each of a plurality of orders of food items from the menu over a period of time averaging less time than the predetermined preparation time period from each of the plurality of customers situated in one of the plurality of time zones over one of the plurality of first communication links;
c. establishing a sufficient number of second communication links between each of the plurality of remote order takers that has negotiated one of the plurality of orders of food items from the menu that was accessible to the local customer placing the order and the local AFPM situated proximate to said local customer;
d. remotely ordering each of the plurality of ordered food items over one of the plurality of second communication links by remotely activating the local AFPM situated proximate to the local customer that placed the order to prepare each of the plurality of ordered food items contemporaneously,
whereby, each of the local customers situated in one of the plurality of time zones can communicate with one of the plurality of remote order takers to order a food item from the menu accessible to said customer and each of the remote order takers can remotely activate the local AFPM proximate to said customer to prepare the ordered food items unconsecutively.

37. The method of ordering at an AFPM of claim 36, wherein the step of establishing the plurality of first communication links between each of the plurality of customers situated in each of the plurality of time zones and each one of a plurality of remote order takers includes the plurality of customers situated in an adjacent plurality of time zones.

38. A system for optimizing ordering during a rush period at a plurality of Automated Food Processing Machines (AFPMs) that are located in a plurality of time zones, each AFPM has a plurality of at least one food item listed on a menu accessible to a local customer situated in one of the plurality of time zones proximate to a local AFPM which is one of the plurality of AFPMs, means for storing the plurality of the at least one food item listed on the menu, and means for contemporaneously receiving and contemporaneously preparing an optimal number of remotely ordered food items that can each be prepared in a predetermined preparation time period, comprising:
a. a plurality of first communication links that each include a voice communication link between each of the plurality of local customers situated in each of the plurality of time zones and one of a plurality of remote order takers, said plurality of remote order takers being sufficient in number and availability to maximize the number of food items that can be prepared by each AFPM during the rush period, said availability being enhanced by situating the plurality of remote order takers in a plurality of time zones for negotiating during the rush period each of a plurality of orders of food items from the menu over a period of time averaging less time than the predetermined preparation time period from each of the plurality of customers situated in one of the plurality of time zones over one of the plurality of first communication links; and
b. a sufficient number of second communication links between each of the plurality of remote order takers that has negotiated one of the plurality of orders of food items from the menu that was accessible to the local customer placing the order and the local AFPM situated proximate to said local customer for remotely ordering each of the plurality of ordered food items over one of the plurality of second communication links by remotely activating the local AFPM situated proximate to the local customer that placed the order to prepare each of the plurality of ordered food items contemporaneously,
whereby, each of the local customers situated in one of the plurality of time zones can communicate with one of the plurality of remote order takers to order a food item from the menu accessible to said customer and each of the remote order takers can remotely activate the local AFPM proximate to said customer to prepare the ordered food items unconsecutively.

39. The system for ordering at an AFPM of claim 38, wherein the plurality of first communication links between each of the plurality of customers situated in each of the plurality of time zones and each one of a plurality of remote order takers includes the plurality of customers situated in an adjacent plurality of time zones.

40. A method of optimizing the use of a plurality of remote order takers during rush periods for negotiating orders at a plurality of Automated Food Processing Machines (AFPMs) that are located in a plurality of adjacent time zones, each of the plurality of AFPMs has a plurality of at least one food item listed on a local menu which is accessible to a local customer situated in one of the first plurality of time zones proximate to a local AFPM which is one of the plurality of AFPMs, means for storing the plurality of the at least one food item listed on the menu, and means for contemporaneously receiving and contemporaneously preparing a plurality of remotely ordered food items, comprising:
a. establishing at least two shifts of remote order takers, each of said shifts starting to take orders at a different time;
b. establishing a plurality of first communication links that each include a voice communication link between each of a plurality of local customers and an available one of the at least two groups of remote order takers for taking orders during rush periods, including at least one of a breakfast rush period in the morning, a lunch rush period in the mid-day, and a dinner rush period in the evening in each of the plurality of adjacent time zones in which the plurality of AFPMs are located, wherein the breakfast rush period of a first adjacent time zone commences before the breakfast rush period of a second adjacent time zone and the breakfast rush period of the first adjacent time zone generally ends after the breakfast rush period of the second adjacent time zone commences, so that the breakfast rush period of a number of adjacent time zones will commence with the breakfast rush period of the first adjacent time zone and continue until the breakfast rush period of the last of the number of adjacent time zones ends, wherein the lunch rush period of the first adjacent time zone commences before the lunch rush period of the second adjacent time zone and the lunch rush period of the first adjacent time zone generally ends after the lunch rush period of the second adjacent time zone commences, so that the lunch rush period of a number of adjacent time zones will commence with the lunch rush period of the first adjacent time zone and continue until the lunch rush period of the last of the number of adjacent time zones ends, and wherein a dinner rush period of the first adjacent time zone commences before the dinner rush period of the second adjacent time zone and the dinner rush period of the first adjacent time zone generally ends after the dinner rush period of the second adjacent time zone commences, so that the dinner rush period of a number of adjacent time zones will commence with the dinner rush period of the first adjacent time zone and continue until the dinner rush period of the last of the number of adjacent time zones ends, and wherein at least one of (I) the breakfast rush period of the number of adjacent time zones and the lunch rush period of the number of adjacent time zones and (ii) the lunch rush period of the number of adjacent time zones and the dinner rush period of the number of adjacent time zones overlap, so that the rush periods of the number of adjacent time zones in which an above average number of the plurality of orders are generated from the plurality of local customers situated in the respective adjacent plurality of time zones extend substantially throughout the at least two shifts of remote order takers;
c. negotiating each of a plurality of orders of food items from one of the local menus from each of the plurality of local customers situated in one of the plurality of adjacent time zones over one of the plurality of first communication links;
d. establishing a plurality of second communication links between each of the plurality of remote order takers that has negotiated one of the plurality of orders of food items from the menu that was accessible to the local customer placing the order and the local AFPM situated proximate to said local customer;
e. remotely ordering each of the plurality of ordered food items over one of the plurality of second communication links by each of the remote order takers remotely activating the local AFPM situated proximate to the local customer that placed the order to prepare one of the plurality of ordered food items,
whereby, each of said at least two shifts of remote order takers can support the other of said at least two shifts of remote order takers to efficiently negotiate orders and activate one of the plurality of AFPMs during rush periods in a number of adjacent time zones independent of substantial idle time intervals during the at least two shifts of remote order takers.
